(19) United States
(12) Patent Application Publication
(10) Pub. No.: US 2024/0408780 A1
(43) Pub. Date: Dec. 12, 2024

(54) RAZOR CARTRIDGE

(71) Applicant: DORCO CO., LTD., Yongin-si (KR)

(72) Inventors: Nam Ri KIM, Seoul (KR); Ji Hoon YANG, Seoul (KR); Da Woon HAN, Seoul (KR)

(21) Appl. No.: 18/678,575

(22) Filed: May 30, 2024

(30) Foreign Application Priority Data
Jun. 9, 2023 (KR) 10-2023-0074319

(51) Int. Cl. B26B 21/40; B26B 21/44

(52) U.S. Cl. CPC B26B 21/4031; B26B 21/443

(57) ABSTRACT

A razor cartridge is proposed. The razor cartridge may include at least one razor blade having a cutting edge, a blade housing for accommodating the at least one razor blade in a longitudinal direction, and a plurality of clips for retaining the at least one razor blade in the blade housing on both sides of the longitudinal direction. The at least one razor blade may have a positive exposure value when one end of the cutting edge is located at an upper portion in the height direction and a negative exposure value when one end of the cutting edge is located at a lower portion in the height direction with respect to a virtual plane. With respect to a clip plane, the side portion exposure value of each of the at least one razor blade may be greater than the central portion exposure value.

### CROSS-REFERENCE TO RELATED APPLICATION

This patent application claims priority to Patent Application No. 10-2023-0074319, filed in Korea on Jun. 9, 2023, which is incorporated herein by reference in its entirety.

### BACKGROUND

### Technical Field

The present disclosure relates to a razor cartridge.

### Description of Related Technology

A razor cartridge may include at least one shaving blade having a cutting edge, a blade housing to accommodate the razor blade, a plurality of clips that retain the razor blade in the blade housing, a guard disposed in front or rear of the at least one razor blade, and a cap disposed in front or rear of the at least one razor blade.

### SUMMARY

One aspect is a razor cartridge that satisfies various shaving purposes and performance depending on the shape and exposure value of a razor blade, and provides a razor cartridge that allows for more functional and precise shaving by controlling the exposure value of the razor blade based on a constant shaving plane that does not change each time shaving.

Another aspect is a razor cartridge, comprising: at least one razor blade having a cutting edge; a blade housing for accommodating the at least one razor blade in a longitudinal direction, the blade housing comprising a top surface toward which the cutting edge faces and a bottom surface opposing the top surface; and a plurality of clips for retaining the at least one razor blade in the blade housing on both sides of the longitudinal direction, wherein: when a direction parallel to the direction from the bottom surface to the top surface is referred to as a height direction, the at least one razor blade has a positive exposure value when one end of the cutting edge is located at an upper portion in the height direction with respect to a virtual plane, and the at least one razor blade has a negative exposure value when one end of the cutting edge is located at a lower portion in the height direction with respect to the virtual plane, with respect to the virtual plane, an exposure value measured in a direction parallel to the height direction at one longitudinal side portion of the cutting edge of each of the at least one razor blade is defined as a side portion exposure value, and an exposure value measured in a direction parallel to the height direction at a longitudinal central portion of the cutting edge of each of the at least one razor blade is defined as a central portion exposure value, and with respect to a clip plane tangential to the uppermost end of the plurality of clips in the height direction, the side portion exposure value of each of the at least one razor blade is greater than the central portion exposure value.

As described above, according to various embodiments of the present disclosure, various shaving purposes and performance can be satisfied depending on the shape and exposure value of a razor blade, even when actual shaving is performed. Furthermore, more functional and precise shaving can be achieved by controlling the exposure value of the razor blade based on a constant shaving plane that does not change each time shaving.

### BRIEF DESCRIPTION OF THE DRAWINGS

FIG. 1 is a perspective view of a razor cartridge according to an embodiment of the present disclosure.

FIG. 2 is a front view of the relationship between one razor blade and a clip plane with some components of the razor cartridge of FIG. 1 omitted.

FIG. 3A is a cross-sectional view of the razor cartridge according to a first embodiment of the present disclosure as viewed from the side, taken in a direction of A-A′.

FIG. 3B is a schematic diagram illustrating the exposure value of each of a plurality of razor blades omitting some components of the razor cartridge according to a first embodiment of the present disclosure.

FIG. 4A is a cross-sectional view of the razor cartridge according to a second embodiment of the present disclosure as viewed from the side, taken in a direction of A-A′.

FIG. 4B is a schematic diagram illustrating the exposure value of each of a plurality of razor blades omitting some components of the razor cartridge according to a second embodiment of the present disclosure.

FIG. 5 is a top view of a razor cartridge according to a third embodiment of the present disclosure.

FIG. 6 is a top view of a razor cartridge according to a fourth embodiment of the present disclosure.

FIG. 7 is a top view of a razor cartridge according to a fifth embodiment of the present disclosure.

### DETAILED DESCRIPTION

The shape, dimensions, exposure value, and disposition structure of a plurality of razor blades of the razor blade have a great influence on the purpose and performance of shaving. Recently, as the purposes for which users shave have become more diverse, various razor cartridges are being developed to suit different purposes.

For example, when the force required to cut body hair is called cutting force, there may be needed a razor cartridge with greater cutting force but longer skin safety and longer lifespan, or a razor cartridge that has a short lifespan and may irritate the skin, but has a small cutting force that allows for a clean shave. In addition, there may be needed a razor cartridge that may effectively shave in curved areas of the skin.

As such, in order to provide appropriate shaving performance according to the shaving purpose, the shape and exposure value of the razor blade and the disposition structure of the plurality of razor blades are important factors. However, conventional razor cartridges had the limitation of not comprehensively considering the correlation between the above factors or the impact on shaving performance due to this correlation.

In addition, in a current razor cartridge, the reference plane in relation to the exposure value of the razor blade is defined as a plane connecting the uppermost part of the cap and the guard. For example, with respect to the plane connecting the uppermost part of the cap and the guard, when the uppermost end of the cutting edge of the razor blade is located at an upper portion of the plane, the exposure value is defined as being positive, and when the uppermost end of the cutting edge of the razor blade is located at a lower portion of the plane, the exposure value is defined as being negative.

However, most guards currently sold on the market are made of rubber material, so the height is easily deformed due to the elasticity of the rubber material. The cap includes a lubrication band, and thus may swell as a whole due to water-soluble ingredients when shaving, or may wear out or shrink as a whole when more than a certain amount of lubricating ingredient is used.

As a result, the plane defined using the guard and cap may continuously change when a user uses the cartridge for actual shaving. As in the related art, when the exposure value of the razor blade is defined based on this variable plane, there is an issue that the actual purpose and performance of the razor cartridge may not be guaranteed.

Hereinafter, some embodiments of the present disclosure will be described in detail with reference to the accompanying drawings. It is to be noted that in giving reference numerals to components of each of the accompanying drawings, the same components will be denoted by the same reference numerals even though they are illustrated in different drawings. Further, in describing exemplary embodiments of the present invention, well-known functions or constructions will not be described in detail since they may unnecessarily obscure the understanding of the present invention.

Terms ‘first’, ‘second’, i), ii), a), b), and the like, will be used in describing components according to embodiments of the present disclosure. These terms are only for distinguishing the components from other components, and the nature, sequence, order, or the like of the components are not limited by the terms. Throughout the present specification, unless explicitly described to the contrary, “including” or “comprising” any components will be understood to imply the inclusion of other elements rather than the exclusion of any other elements.

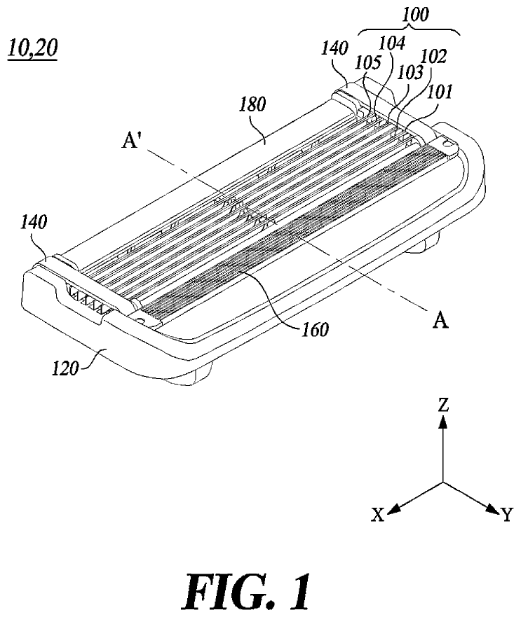

FIG. 1 is a perspective view of a razor cartridge 10 according to an embodiment of the present disclosure.

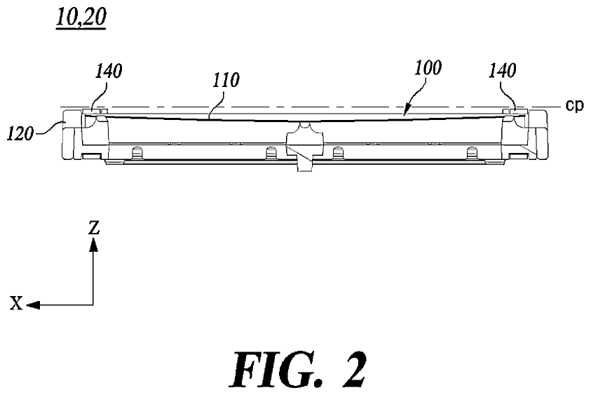

FIG. 2 is a front view of the relationship between one razor blade 100 and a clip plane (CP) with some components of the razor cartridge 10 or 20 of FIG. 1 omitted.

Referring to FIGS. 1 and 2, the razor cartridge 10 or 20 according to an embodiment of the present disclosure includes at least one razor blade 100, a blade housing 120, a plurality of clips 140, a first contact member 160, and a second contact member 180.

The at least one razor blade 100 has a cutting edge 110. The cutting edge 110 is configured to cut the body hair of a user during shaving.

The blade housing 120 accommodates the at least one razor blade 100 in a longitudinal direction. Herein, the longitudinal direction may mean a direction parallel to the X-axis in FIGS. 1 and 2.

The blade housing 120 includes a top surface toward which the cutting edge 110 faces and a bottom surface opposing the top surface. When the direction from the bottom surface to the top surface is referred to as a height direction, the height direction may mean a direction parallel to the Z axis in FIGS. 1 and 2.

Herein, the at least one razor blade 100 has a positive exposure value (exposure value) when one end of the cutting edge 110 is located at an upper portion in the height direction, and has a negative exposure value when one end of the cutting edge 110 is located at a lower portion in the height direction with respect to a virtual plane.

In addition, with respect to the virtual plane, the exposure value measured in a direction parallel to the height direction at one longitudinal side portion of the cutting edge 110 of each of the at least one razor blade 100 is defined as a side portion exposure value, and the exposure value measured in a direction parallel to the height direction at a longitudinal central portion of the cutting edge 110 of each of the at least one razor blade 100 is defined as a central portion exposure value.

The plurality of clips 140 retains the at least one razor blade 100 in the blade housing 120 on both sides of the longitudinal direction. The plurality of clips 140 may be made of a rigid, wear-resistant material, for example, a metal material. Accordingly, the height of the upper portions of the plurality of clips 140 may be constant even when repeated shaving is performed or the shaving environment changes.

The plane tangential to the uppermost end of the plurality of clips 140 in the height direction is defined as the CP. When the plurality of clips 140 are made of a metal material, the CP may remain substantially the same as the initially defined plane even when repeated shaving is performed or the shaving environment changes.

The CP may be parallel to the top surface or bottom surface, but an upper surface of the clip 140 is not necessarily configured to be parallel to the CP. For example, depending on the height of both longitudinal sides of the at least one razor blade 100, at least a portion of the upper surface of the clip 140 may be configured to be inclined with respect to the top surface or the bottom surface.

With respect to the CP, the side portion exposure value of each of the at least one razor blades 100 is configured to be greater than the central portion exposure value. Accordingly, referring to FIG. 2, the cutting edge 110 of at least one razor blade 100 may have a downwardly convex shape when viewed from the front.

As such, the razor cartridge 10 or 20 according to an embodiment of the present disclosure is configured such that the side portion exposure value of each of the at least one razor blade 100 is greater than the central portion exposure value, thereby achieving safe shaving by minimizing the overall irritation applied to the skin of a user.

Since human skin is elastic, when a user shaves, the skin is pressed by the razor cartridge and a certain portion of the skin is pressed. The part that is not pressed becomes relatively convex. When the razor blade and the skin are placed close together for shaving, the skin is pressed by the clip of the razor cartridge and the central portion of the pressed skin is convex downward.

A user generally performs shaving by placing the central portion of the razor cartridge on the area to shave. During shaving, the skin of the user is pressed by the razor cartridge and shaved in a convex downward state. The razor cartridge 10 or 20 according to an embodiment of the present disclosure is effective in providing the safest and optimal shaving that corresponds to the curves of the skin of the user.

More specifically, since a longitudinal side region of the razor blade 100 is supported by the clip 140 and may cause less irritation to the skin, the razor cartridge 10 or 20 according to an embodiment of the present disclosure may be configured to improve adhesion to the skin by relatively increasing the side portion exposure value of the razor blade 100. In addition, since a longitudinal central region of the razor blade 100 does not have a separate configuration to support the region, the razor cartridge 10 or 20 according to an embodiment of the present disclosure may be configured to improve safety by relatively reducing the central portion exposure value of the razor blade 100 to correspond to stretched skin.

Since the central portion exposure value and/or the side portion exposure value may have a negative exposure value with respect to the CP, the at least one razor blade 100 may reduce overall irritation applied to the skin. Simultaneously, the at least one razor blade 100 is configured to have the central portion exposure value smaller than the side portion exposure value, thereby providing an optimal shave corresponding to the skin curvature of a user.

For example, the side portion exposure value of the at least one razor blade 100 may be −0.597 mm to −0.37 mm with respect to the CP. Additionally, the central portion exposure value of the at least one razor blade 100 may be −0.632 mm to −0.376 mm.

In addition, the at least one razor blade 100 may include all or part of a first razor blade 101, a second razor blade 102, a third razor blade 103, a fourth razor blade, and a fifth razor blade 105. Herein, the shapes of each of the plurality of razor blades 101, 102, 103, 104, and 105 may be the same or different from each other.

With respect to the shaving direction, the first razor blade 101 is disposed relatively at front, the second razor blade 102 is disposed at rear of the first razor blade 101, the third razor blade 103 is disposed at rear of the second razor blade 102, the fourth razor blade 104 is disposed at rear of the third razor blade 103, and the fifth razor blade 105 is disposed at rear of the fourth razor blade 104.

Herein, the shaving direction may refer to a direction parallel to the Y-axis in FIG. 1, and accordingly, the front may refer to a positive Y-axis direction and the rear may refer to a negative Y-axis direction. The relationship between the plurality of razor blades 101, 102, and 103 will be described in detail in the drawings to be described later.

The first contact member 160 may be disposed at front of the at least one razor blade 100 with respect to the shaving direction, and may include a rubber material or a lubrication material. For example, the first contact member 160 may be a guard made of rubber.

The second contact member 180 may be disposed at rear of the at least one razor blade 100 with respect to the shaving direction, and may include a rubber material or a lubrication material. For example, the second contact member 180 may be a cap including a lubrication material.

Herein, when the razor cartridge 10 or 20 is completely dry and unused without moisture, the plane tangential to an upper portion of the first contact member 160 and an upper portion of the second contact member 180 may be defined as a shaving plane (SP). For example, the at least one razor blade 100 may have an exposure value of −0.25 mm to 0.15 mm, and preferably may have an exposure value of −0.23 mm to 0.13 mm, with respect to the SP.

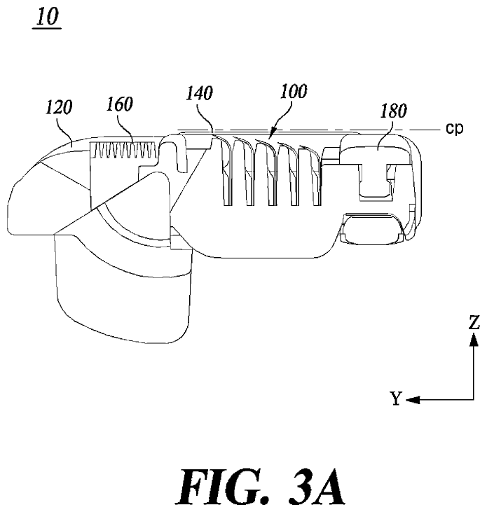

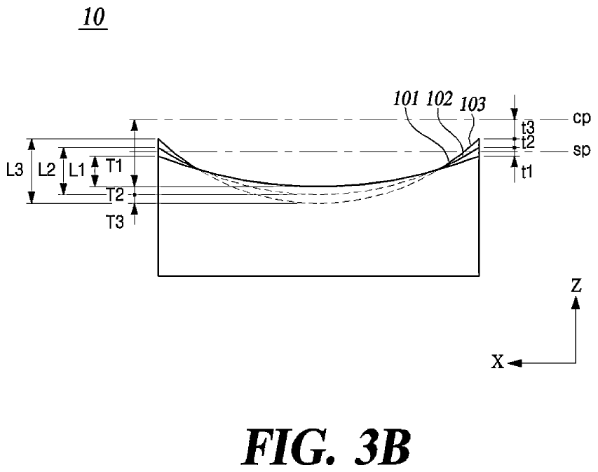

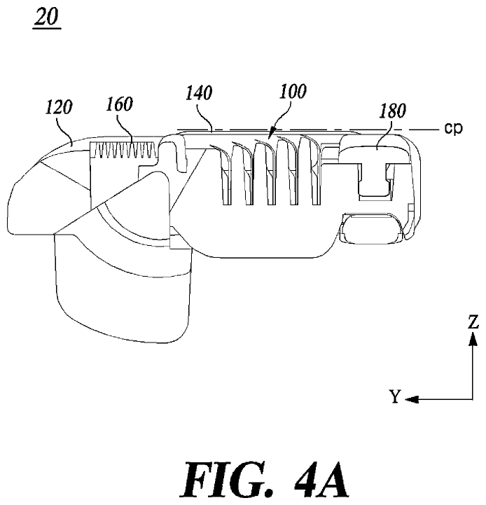

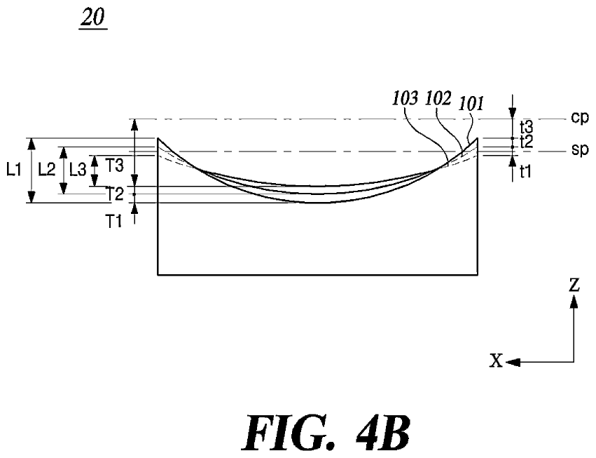

Referring to FIGS. 3A to 4B in advance, the at least one razor blade 100 may always have a negative exposure value with respect to the CP, but the negative exposure value may also have a positive exposure value with respect to the SP.

In addition, the at least one razor blade 100 includes a first razor blade 101 and a second razor blade 102. When the central portion exposure value of the first razor blade 101 is smaller than the central portion exposure value of the second razor blade 102 with respect to the CP, the central portion exposure value of the first razor blade 101 may be smaller or larger than the central portion exposure value of the second razor blade 102 with respect to the SP.

However, the height of the contact member made of rubber is easily deformed each time shaving due to the elasticity of the rubber material, and the contact member including a lubrication material may swell when shaving due to water or shrink or wear out due to repeated use.

Accordingly, when the SP is defined based on the guard and cap like a typical razor cartridge, and the exposure value of the razor blade is defined accordingly, the SP changes each time shaving or the SP easily changes due to humidity, making it difficult to ensure the originally intended performance and purpose of shaving.

The razor cartridge 10 or 20 according to an embodiment of the present disclosure defines the exposure value of the at least one razor blade 100 with respect to the clip plane CP, so that the plane that serves as the basis for the exposure value is almost constant each time shaving. Accordingly, the initially intended purpose and performance of the razor cartridge 10 or 20 may always be maintained.

FIG. 3A is a cross-sectional view of the razor cartridge 10 according to a first embodiment of the present disclosure as viewed from the side, taken in a direction of A-A′.

FIG. 3B is a schematic diagram illustrating the exposure value of each of a plurality of razor blades 101, 102, and 103 omitting some components of the razor cartridge 10 according to a first embodiment of the present disclosure.

Referring to FIGS. 3A and 3B, in the razor cartridge 10 according to the first embodiment of the present disclosure, the central portion exposure value of the first razor blade 101 may be configured to be greater than the central portion exposure value of the second razor blade 102 with respect to the CP. For example, a difference between the central portion exposure value of the first razor blade 101 and the central portion exposure value of the second razor blade 102 may be 0.001 mm to 0.02 mm, but is not necessarily limited thereto.

In addition, when the at least one razor blade 100 includes the first razor blade 101, the second razor blade 102, and the third razor blade 103, each of central portion exposure values T1, T2, and T3 of the first razor blade 101, the second razor blade 102, and the third razor blade 103 may be configured to decrease in that order.

In FIG. 3B, the at least one razor blade 100 is illustrated as including three razor blades, but this is an example and the number of razor blades may vary.

In this connection, the central portion exposure value of the razor blade disposed relatively at front may be greater than the central portion exposure value of the razor blade disposed at rear. Accordingly, a clean shave may be possible from the beginning with the razor blade disposed at front, and a safer shave may be possible overall from the front to the rear in a central region of the razor cartridge 10.

In particular, depending on the shaving habits and shaving region of a user, there may be cases where more force is applied from the rear part of the razor cartridge 10 during a shaving stroke. For example, there may be cases where the user has a habit of applying more force at the end of the shaving stroke. In this connection, the skin at the rear part of the razor cartridge 10 may have a relatively more convex shape due to the greater pressing force. Accordingly, in this connection, it may be more effective to configure the central portion exposure value of the razor blades to decrease from the front to the rear.

Additionally, with respect to the CP, the side portion exposure value of the first razor blade 101 may be configured to be smaller than the side portion exposure value of the second razor blade 102. In addition, when the at least one razor blade 100 includes the first razor blade 101, the second razor blade 102, and the third razor blade 103, each of side portion exposure values t1, t2, and t3 of the first razor blade 101, the second razor blade 102, and the third razor blade 103 may be configured to increase in that order.

In this connection, the side portion exposure value of the razor blade disposed relatively at front may be smaller than the side portion exposure value of the razor blade disposed at rear. Accordingly, it may be possible to shave closer to the skin in a longitudinal side region of the razor cartridge 10 from the front to the rear as a whole.

As a result, it is possible to provide the razor cartridge 10 that has safety in the longitudinal central region of the razor cartridge 10 and skin adhesion in the longitudinal side region of the razor cartridge 10 from the front to the rear. Accordingly, it is possible to provide the razor cartridge 10 that has overall safety and skin adhesion.

The portion of body hair that has not been removed cleanly due to the low central portion exposure value of the rear razor blade in the longitudinal central region of the razor cartridge 10 may be removed by a user moving the razor cartridge 10 slightly in the longitudinal direction to proceed with shaving.

When the central portion exposure value of the razor blade disposed relatively at front is greater than the central portion exposure value of the razor blade disposed at rear, and the side portion exposure value of the razor blade disposed relatively at front is smaller than the side portion exposure value of the razor blade disposed at rear, the downward convexity of the razor blades may increase from the front to the rear when viewed from the front.

For example, when the height distance between an imaginary line connecting both longitudinal side portions and the longitudinal central portion is referred to as a vertical separation distance, from the front to the rear, the vertical separation distances L1, L2, and L3 of each of the first razor blade 101, the second razor blade 102, and the third razor blade 103 may gradually increase. Herein, the vertical separation distance is an absolute value and always has a positive value.

Accordingly, in a case where the degree of skin curvature becomes more severe along the shaving direction depending on the skin elasticity of a user, the razor cartridge 10 according to the first embodiment may provide optimal shaving.

FIG. 4A is a cross-sectional view of the razor cartridge 20 according to a second embodiment of the present disclosure as viewed from the side, taken in a direction of A-A′.

FIG. 4B is a schematic diagram illustrating the exposure value of each of a plurality of razor blades 101, 102, and 103 omitting some components of the razor cartridge 20 according to a second embodiment of the present disclosure.

Referring to FIGS. 4A and 4B, in the razor cartridge 20 according to the second embodiment of the present disclosure, the central portion exposure value of the first razor blade 101 may be configured to be greater than the central portion exposure value of the second razor blade 102 with respect to the CP. For example, the difference between the central portion exposure value of the first razor blade 101 and the central portion exposure value of the second razor blade 102 may be 0.001 mm to 0.02 mm, but is not necessarily limited thereto.

In addition, when the at least one razor blade 100 includes the first razor blade 101, the second razor blade 102, and the third razor blade 103, each of central portion exposure values T1, T2, and T3 of the first razor blade 101, the second razor blade 102, and the third razor blade 103 may be configured to increase in that order.

In FIG. 4B, the at least one razor blade 100 is illustrated as including three razor blades, but this is an example and the number of razor blades may vary.

In this connection, the central portion exposure value of the razor blade disposed relatively at rear may be greater than the central portion exposure value of the razor blade disposed at front. Accordingly, skin adhesion increases overall from the front to the rear in the central region of the razor cartridge 20, enabling a clean shave and reducing initial shaving irritation.

In particular, depending on the shaving habits and shaving region of a user, there may be cases where more force is applied from the front part of the razor cartridge 20 during a shaving stroke. For example, there may be cases where the user has a habit of applying more force at the end of the shaving stroke. In this connection, the skin at the front part of the razor cartridge 20 may have a relatively more convex shape due to the greater pressing force. Accordingly, in this connection, it may be more effective to configure the central portion exposure value of the razor blades to increase from the front to the rear.

Additionally, with respect to the CP, the side portion exposure value of the first razor blade 101 may be configured to be greater than the side portion exposure value of the second razor blade 102. In addition, when the at least one razor blade 100 includes the first razor blade 101, the second razor blade 102, and the third razor blade 103, each of side portion exposure values t1, t2, and t3 of the first razor blade 101, the second razor blade 102, and the third razor blade 103 may be configured to decrease in that order.

In this connection, the side portion exposure value of the razor blade disposed relatively at front may be smaller than the side portion exposure value of the razor blade disposed at rear. Accordingly, it may be possible to safety shave the skin in a longitudinal side region of the razor cartridge 20 from the front to the rear as a whole.

As a result, it is possible to provide the razor cartridge 20 that has skin adhesion in a longitudinal central region of the razor cartridge 20 and safety in the longitudinal side region of the razor cartridge 20 from the front to the rear. Accordingly, it is possible to provide the razor cartridge 20 that has overall safety and skin adhesion.

The portion of body hair that has not been removed cleanly due to the low central portion exposure value of the front razor blade in the longitudinal central region of the razor cartridge 20 may be removed by a user moving the razor cartridge 20 slightly in the longitudinal direction to proceed with shaving.

When the central portion exposure value of the razor blade disposed relatively at front is smaller than the central portion exposure value of the razor blade disposed at rear, and the side portion exposure value of the razor blade disposed relatively at front is greater than the side portion exposure value of the razor blade disposed at rear, the downward convexity of the razor blades may decrease from the front to the rear when viewed from the front. For example, when the height distance between an imaginary line connecting both sides in the longitudinal direction and the longitudinal center is referred to as a vertical separation distance, from the front to the rear, the vertical separation distances L1, L2, and L3 of each of the first razor blade 101, the second razor blade 102, and the third razor blade 103 may gradually decrease.

Accordingly, in a case where the degree of skin curvature becomes weaker along the shaving direction depending on the skin elasticity of a user, the razor cartridge 20 according to the second embodiment may provide optimal shaving.

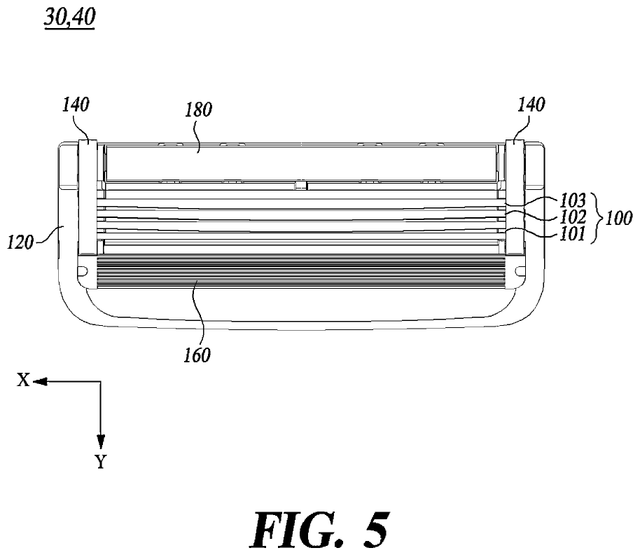

FIG. 5 is a top view of a razor cartridge 30 according to a third embodiment of the present disclosure.

Referring to FIG. 5, when the razor cartridge 30 according to the third embodiment of the present disclosure is viewed from the top, with respect to the shaving direction, the longitudinal central portion of each of the at least one razor blade 100 may be configured to be disposed more adjacent to the front than the both longitudinal side portions. Accordingly, when viewed from the top, the cutting edge 110 of the at least one razor blade 100 may have a downward convex shape.

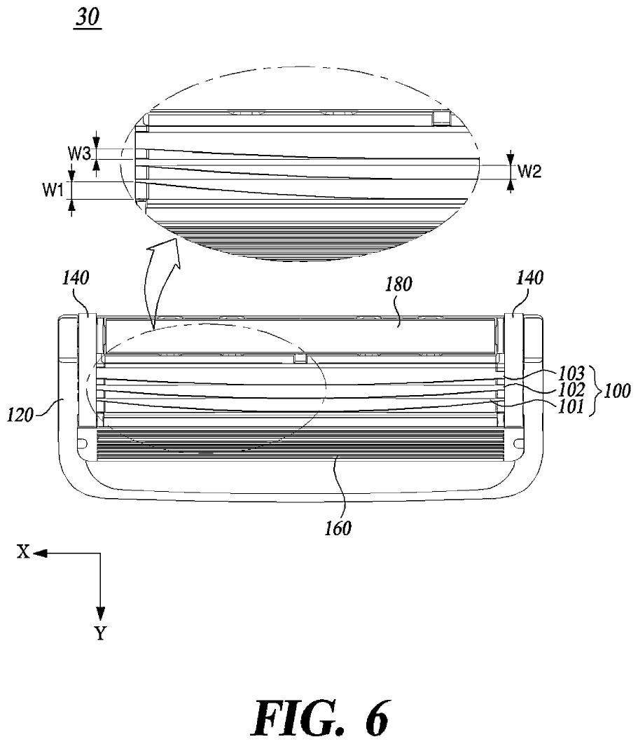

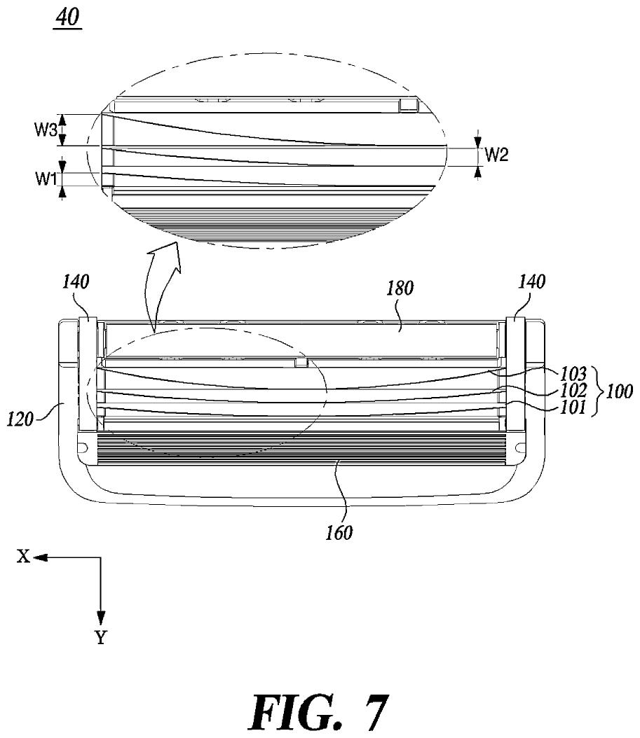

In FIG. 5, it is illustrated that the at least one razor blade 100 includes three razor blades, and all three razor blades have the same degree of convexity, but the number and shape are not necessarily limited thereto. The matter that the plurality of razor blades 100 have different degrees of convexity will be described in detail in FIGS. 6 and 7 to be described later.

Compared to a razor blade having a cutting edge parallel to the longitudinal direction when viewed from the top, as soon as the razor blade having the cutting edge 110 that is convex downward starts cutting, the region tangential to the body hair forms a diagonal line with the body hair, except for the central part. Accordingly, relatively efficient cutting may occur by concentrating the cutting force on one longitudinal side of the body hair.

Relatively efficient cutting of the body hair may prevent tearing that may occur as body hair lies down, so a razor blade that is convex downward when viewed from the top has the benefit of cutting hair cleanly compared to a horizontal razor blade.

In addition, the longitudinal central portion of each of the at least one razor blade 100 is configured to be disposed more adjacent to the front than the both longitudinal side portions, so that the both longitudinal side portions may form a relatively more inclined tangent to the body hair, resulting in low cutting force. Considering that the part where a user generally applies the greatest force during shaving is the central region of the razor cartridge 30, it is advantageous to provide optimal shaving by configuring the cutting force to be lower on the both longitudinal side portions where relatively less force is transmitted.

Additionally, the razor cartridge 30 according to another embodiment of the present disclosure may be configured to include the razor cartridge 10 or 20 according to an embodiment of the present disclosure, but is not necessarily limited thereto.

FIG. 6 is a top view of a razor cartridge 40 according to a fourth embodiment of the present disclosure.

Referring to FIG. 6, when the distance in the lateral direction perpendicular to the longitudinal direction between an imaginary line connecting the both longitudinal side portions and the longitudinal central portion is referred to as a horizontal separation distance, the razor cartridge 40 according to the fourth embodiment of the present disclosure may be configured such that a horizontal separation distance W1 of the first razor blade 101 is greater than a horizontal separation distance W2 of the second razor blade 102. In addition, the horizontal separation distance W2 of the second razor blade 102 may be configured to be greater than a horizontal separation distance W3 of the third razor blade 103. Herein, the horizontal separation distance is an absolute value and always has a positive value.

In this connection, when viewed from the top, the downward convexity of the razor blades 101, 102, and 103 may decrease from the front to the rear. Accordingly, the lateral span between adjacent razor blades may become smaller as one moves from the longitudinal center of the razor cartridge 40 to the side.

Accordingly, discharge of shaving materials may be relatively easy in the longitudinal central region of the razor cartridge 40, and a relatively clean shave may be achieved by the dense razor blades 101, 102, and 103 in the longitudinal side region.

Additionally, the razor cartridge 40 according to another embodiment of the present disclosure may be configured to include the razor cartridge 10 or 20 according to an embodiment of the present disclosure, but is not necessarily limited thereto.

FIG. 7 is a top view of a razor cartridge 50 according to a fifth embodiment of the present disclosure.

Referring to FIG. 7, when the distance in the lateral direction perpendicular to the longitudinal direction between an imaginary line connecting the both longitudinal side portions and the longitudinal central portion is referred to as a horizontal separation distance, the razor cartridge 50 according to the fifth embodiment of the present disclosure may be configured such that the horizontal separation distance W1 of the first razor blade 101 is smaller than the horizontal separation distance W2 of the second razor blade 102. In addition, the horizontal separation distance W2 of the second razor blade 102 may be configured to be smaller than the horizontal separation distance W3 of the third razor blade 103.

In this connection, when viewed from the top, the downward convexity of the razor blades 101, 102, and 103 may increase from the front to the rear. Accordingly, the lateral span between adjacent razor blades may become greater as one moves from the longitudinal center of the razor cartridge 50 to the side.

Accordingly, a relatively clean shave may be achieved by the dense razor blades 101, 102, and 103 in the longitudinal side region of the razor cartridge 50, and discharge of shaving materials may be relatively easy in the longitudinal side region.

Additionally, the razor cartridge 50 according to another embodiment of the present disclosure may be configured to include the razor cartridge 10 or 20 according to an embodiment of the present disclosure, but is not necessarily limited thereto.

The spirit of the present embodiment is illustratively described hereinabove. It will be appreciated by those skilled in the art to which the present embodiment pertains that various modifications and alterations may be made without departing from the essential characteristics of the present embodiment. Accordingly, the present embodiments are not to limit the spirit of the present embodiment, but are to describe the spirit of the present embodiment. The technical idea of the present embodiment is not limited to these embodiments. The scope of the present embodiment should be interpreted by the following claims, and it should be interpreted that all the spirits equivalent to the following claims fall within the scope of the present embodiment.

What is claimed is:

1. A razor cartridge, comprising:
at least one razor blade comprising a cutting edge;
a blade housing configured to accommodate the at least one razor blade in a longitudinal direction, the blade housing comprising a top surface toward which the cutting edge faces and a bottom surface opposing the top surface; and
a plurality of clips configured to retain the at least one razor blade in the blade housing on both sides of the longitudinal direction, wherein:
when a direction parallel to the direction from the bottom surface to the top surface is referred to as a height direction,
the at least one razor blade is configured to have a positive exposure value in response to one end of the cutting edge being located at an upper portion in the height direction with respect to a virtual plane,
the at least one razor blade is configured to have a negative exposure value in response to one end of the cutting edge being located at a lower portion in the height direction with respect to the virtual plane,
with respect to the virtual plane, an exposure value measured in a direction parallel to the height direction at one longitudinal side portion of the cutting edge of each of the at least one razor blade is defined as a side portion exposure value, and an exposure value measured in a direction parallel to the height direction at a longitudinal central portion of the cutting edge of each of the at least one razor blade is defined as a central portion exposure value, and
with respect to a clip plane tangential to the uppermost end of the plurality of clips in the height direction, the side portion exposure value of each of the at least one razor blade is greater than the central portion exposure value.

2. The razor cartridge of claim 1, wherein the at least one razor blade has a negative exposure value with respect to the clip plane.

3. The razor cartridge of claim 1, wherein the side portion exposure value of the at least one razor blade is −0.597 mm to −0.37 mm with respect to the clip plane.

4. The razor cartridge of claim 1, wherein the central portion exposure value of the at least one razor blade is −0.632 mm to −0.376 mm with respect to the clip plane.

5. The razor cartridge of claim 1, wherein the at least one razor blade comprises a first razor blade disposed relatively at front with respect to a shaving direction, and a second razor blade disposed at rear of the first razor blade relatively with respect to the shaving direction, and
wherein the central portion exposure value of the first razor blade is greater than the central portion exposure value of the second razor blade with respect to the clip plane.

6. The razor cartridge of claim 5, wherein the side portion exposure value of the first razor blade is less than the side portion exposure value of the second razor blade with respect to the clip plane.

7. The razor cartridge of claim 1, wherein the at least one razor blade comprises a first razor blade disposed relatively at front with respect to a shaving direction, and a second razor blade disposed at rear of the first razor blade relatively with respect to the shaving direction, and
wherein the central portion exposure value of the first razor blade is smaller than the central portion exposure value of the second razor blade with respect to the clip plane.

8. The razor cartridge of claim 7, wherein the side portion exposure value of the first razor blade is greater than the side portion exposure value of the second razor blade with respect to the clip plane.

9. The razor cartridge of claim 1, wherein the at least one razor blade comprises a first razor blade and a second razor blade disposed at rear of the first razor blade, and
wherein a value of a difference between the central portion exposure value of the first razor blade and the central portion exposure value of the second razor blade is 0.001 mm to 0.02 mm with respect to the clip plane.

10. The razor cartridge of claim 1, wherein the at least one razor blade comprises a first razor blade disposed relatively at front with respect to a shaving direction, a second razor blade disposed at rear of the first razor blade relatively with respect to the shaving direction, and a third razor blade disposed at rear of the second razor blade relatively with respect to the shaving direction, and
wherein, with respect to the clip plane, the central portion exposure values of each of the first razor blade, the second razor blade, and the third razor blade are configured to increase in that order.

11. The razor cartridge of claim 1, wherein the at least one razor blade comprises a first razor blade disposed relatively at front with respect to a shaving direction, a second razor blade disposed at rear of the first razor blade relatively with respect to the shaving direction, and a third razor blade disposed at rear of the second razor blade relatively with respect to the shaving direction, and
wherein, with respect to the clip plane, the central portion exposure values of each of the first razor blade, the second razor blade, and the third razor blade are configured to decrease in that order.

12. The razor cartridge of claim 1, wherein, when the razor cartridge is viewed from the top, with respect to a shaving direction, the longitudinal central portion of each of the at least one razor blade is disposed more adjacent to the front than both longitudinal side portions.

13. The razor cartridge of claim 12, wherein the at least one razor blade comprises a first razor blade disposed relatively at front with respect to a shaving direction and a second razor blade disposed at rear of the first razor blade relatively with respect to the shaving direction, and
wherein, when a distance in a lateral direction perpendicular to the longitudinal direction between an imaginary line connecting the both longitudinal side portions and the longitudinal central portion is referred to as a separation distance, the separation distance of the first razor blade is greater than the separation distance of the second razor blade.

14. The razor cartridge of claim 12, wherein the at least one razor blade comprises a first razor blade and a second razor blade disposed at rear of the first razor blade, and
wherein, when a distance in a lateral direction perpendicular to the longitudinal direction between an imaginary line connecting the both longitudinal side portions and the longitudinal central portion is referred to as a separation distance, the separation distance of the first razor blade is smaller than the separation distance of the second razor blade.

15. The razor cartridge of claim 1, further comprising:
a first contact member disposed at front of the at least one razor blade with respect to a shaving direction; and
a second contact member disposed at rear of the at least one razor blade with respect to the shaving direction,
wherein, in response to the first contact member and the second contact member being in an unused state without moisture, the at least one razor blade is configured to have the exposure value of −0.25 mm to 0.15 mm with respect to a shaving plane tangential to an upper portion of the first contact member and an upper portion of the second contact member.

16. The razor cartridge of claim 15, wherein the at least one razor blade has a first razor blade and a second razor blade, and wherein:
with respect to the clip plane, the central portion exposure value of the first razor blade is smaller than the central portion exposure value of the second razor blade; and
with respect to the shaving plane, the central portion exposure value of the first razor blade is greater than the central portion exposure value of the second razor blade.

17. The razor cartridge of claim 15, wherein the at least one razor blade comprises a first razor blade and a second razor blade, and wherein:
with respect to the clip plane, the central portion exposure value of the first razor blade is smaller than the central portion exposure value of the second razor blade; and
with respect to the shaving plane, the central portion exposure value of the first razor blade is smaller than the central portion exposure value of the second razor blade.
